(19) United States
(12) Patent Application Publication
(10) Pub. No.: US 2017/0364941 A1
(43) Pub. Date: Dec. 21, 2017

(54) DYNAMIC IN-STORE BARCODE PROMOTIONS

(71) Applicant: Target Brands, Inc., Minneapolis, MN (US)

(72) Inventors: Sarah Elizabeth Fox, Plymouth, MN (US); Shaharyar Ahmed Khan, Brooklyn Park, MN (US); Aaron Leigh Sandness, Chanhassen, MN (US)

(21) Appl. No.: 15/187,130

(22) Filed: Jun. 20, 2016

(51) Int. Cl. G06Q 30/02; G06K 7/14; G06K 19/06

(52) U.S. Cl. CPC G06Q 30/0235; G06K 19/06112; G06K 7/1413; G06K 19/06028

(57) ABSTRACT

A computer-implemented method includes receiving a decoded value multiple times from multiple respective devices. The decoded value is formed by decoding an image of a graphic. For each reception of the decoded value, a reward that is to be awarded for providing the decoded value is identified such that for any one reception of the decoded value, the reward is dependent in part on how many times the decoded value has been received.

### BACKGROUND

One dimensional and two dimensional barcodes can be scanned by dedicated scanners and by image processing software in mobile devices such as phones. During the scanning process, the barcode is decoded to form a decoded value that can then be submitted to a server to retrieve information associated with the barcode. Typically, the information associated with the barcode is static such that each time the barcode is scanned, the same information is returned.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes receiving a decoded value multiple times from multiple respective devices. The decoded value is formed by decoding an image of a graphic. For each reception of the decoded value, a reward that is to be awarded for providing the decoded value is identified such that for any one reception of the decoded value, the reward is dependent in part on how many times the decoded value has been received.

In a further embodiment, a method includes associating a graphic with an event taking place at a retail store and receiving an identifier from a mobile device based on the mobile device capturing an image of the graphic. A reward is identified based on the received identifier based in part on how many times the identifier has previously been received. A notification is sent to the mobile device that the identified reward has been awarded.

In a still further embodiment, a server includes a memory and a processor. The memory holds at least one table describing an event at a retail store. The processor performs steps that include receiving an identifier for the event from a mobile device and accessing the at least one table to determine which of a plurality of rewards to award, wherein the determination is affected by how many times the identifier has previously been received. The at least one table is altered to indicate that the identifier has been received an additional time and an indication is returned to the mobile device that the determined reward has been awarded.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 provides a flow diagram of a method of implementing a rewards event in accordance with one embodiment.

FIG. 2 provides a block diagram of elements used in the method of FIG. 1.

FIG. 3 provides an example of a user interface on a mobile device showing scanning of an event barcode.

FIG. 4 provides an example of a user interface on a mobile device showing an error response when the event has expired.

FIG. 5 provides an example of a user interface showing an error when the user has scanned the event barcode more than a maximum allowed amount.

FIG. 6 is an example of an event table in accordance with one embodiment.

FIG. 7 is an example of an event table in accordance with a second embodiment.

FIG. 8 is an example of a user interface showing the awarding of a reward in accordance with one embodiment.

FIG. 9 is a flow diagram of a method of altering an event in real-time while the event is taking place.

FIG. 10 provides a block diagram of a computing device that can be used as a server or mobile device in the various embodiments.

### DETAILED DESCRIPTION

In the embodiments described below, a system is provided that allows customers of retail establishments to take part in reward events. During the reward event, the retailer distributes a barcode or other encoded image by, for example, installing signs containing the barcode, emailing the barcode, posting the barcode to social media, and direct mailing the barcode. Using a mobile device, the customer captures an image of the barcode and converts the image into a barcode value. The barcode value and a rewards account number are then provided to a reward server, which determines a reward to assign to the customer based in part on the number of times that the barcode has been sent in by other customers. This allows different types of rewards to be assigned at different times during the event and prevents the best rewards from being assigned at the beginning of the event thereby extending the relevancy of the event. In accordance with some embodiments, the event organizer is able to alter the event while it is taking place to change the number or type of awards or the percentage of each type of award.

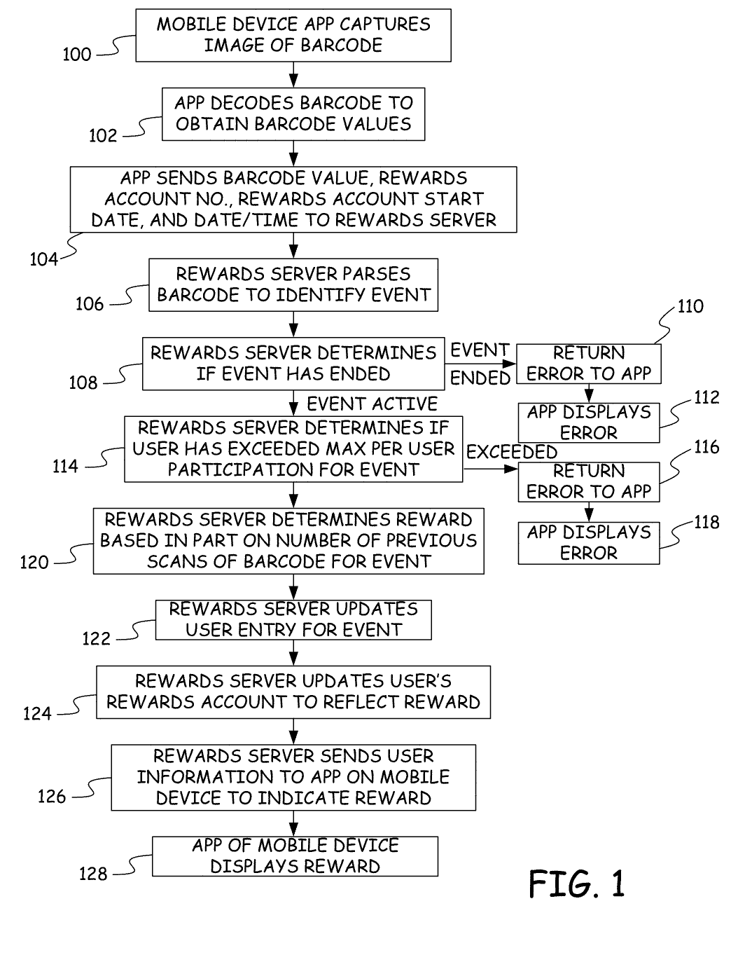

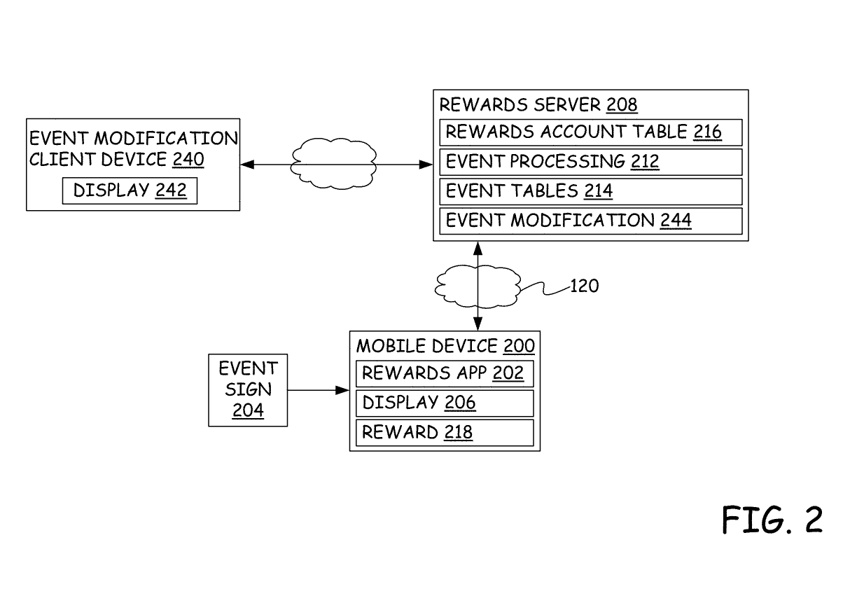

FIG. 1 provides a flow diagram and FIG. 2 provides a block diagram of elements used in executing a rewards event at a retail store. In step 100, a rewards application 202 that is running on a mobile device 200 captures an image of a graphic containing a barcode or other encoded image information. Although only a single mobile device 200 is shown, those skilled in the art will recognize that the embodiments are practiced such that multiple users, each with their own mobile device 200, capture an image of the barcode at different times. The capturing of the image of the barcode is referred to as a barcode scan.

In accordance with one embodiment, the barcode/encoded image is on an event sign 204 that is installed in one or more locations in a retail store during a special event such as “College Night” or that is installed as part of some other promotional offering. In other embodiments, the barcode is on an electronic display such as a television monitor, computer display, or mobile device display. In such embodiments, the barcode is displayed on the electronic display as a result of being sent by email, posted on an Internet site such as a social media site, or sent by text message, for example. In some embodiments the electronic display is located within the retail store and the barcode is displayed on the electronic display in response to instructions executed by a computing device connected to the electronic display. In other embodiments, the barcode is displayed on signs outside of the retail store or is displayed on marketing material that is mailed to a consumer.

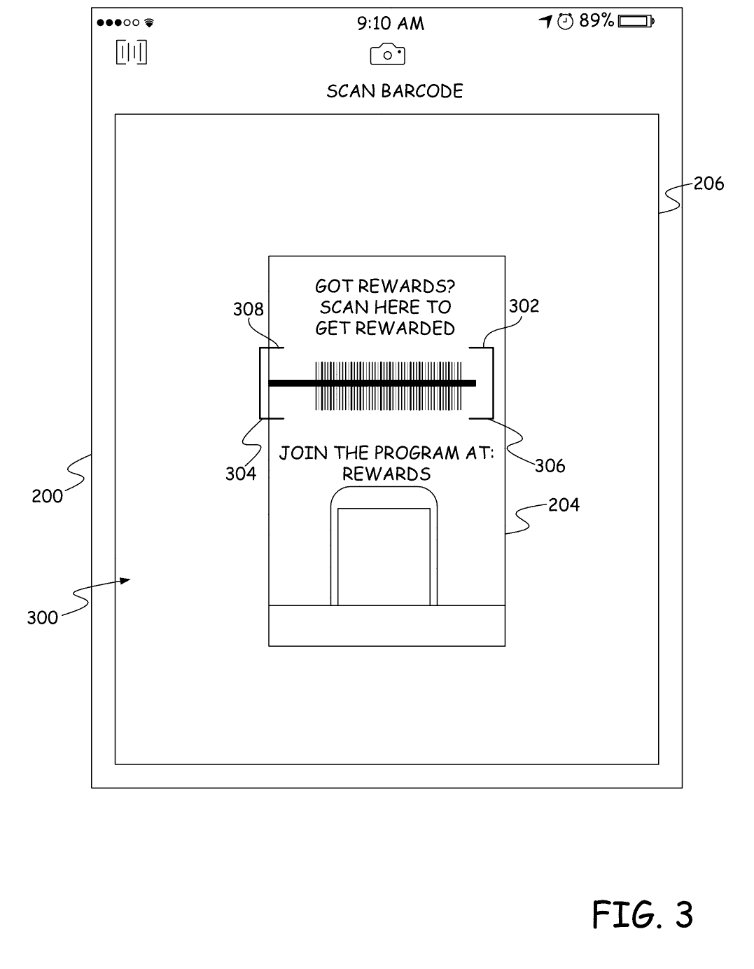

In accordance with one embodiment, rewards application 202 captures the barcode by providing a user interface on display 206 of mobile device 200 that shows an image to be captured by a camera as shown in user interface 300 of FIG. 3. In the user interface, a barcode 302 of event sign 204 is shown on display 206 as captured by a camera of mobile device 200. Rewards application 202 identifies barcode 302 in the image and places delimiters 304 and 306 on the image at the edges of the barcode and a line 308 across the barcode to indicate to the user that the barcode has been captured. In embodiments where the barcode is shown on an electronic display, rewards application 202 captures an image of the barcode on the electronic display. In embodiments where the barcode is located on marketing material, rewards application 202 captures an image of the barcode on the marketing materials.

Once the barcode image has been captured, rewards application 202 decodes the barcode to obtain a decoded value at step 102. In accordance with one embodiment, the decoded value includes a month and year for the event start date (MMYY), a number representing what type of event is taking place (NNNNNN), a number representing a particular event of that type (NNNNNN), and a random number (NNNN). The event type is a sequential number for event types as defined by the event designers. For example, the number “000001” can be for a “back to college” event. The event number is a sequential number of an event within a particular event type. For example, the combination of the event type 000001 with the event number 000001 (000001000001) can equate to a back to college event at a first university while the combined event type and event number 000001000002 can be for a back to college event for a second university. The random number is provided to prevent the decoded values from being sequentially numbered so as to avoid fraudulent submission of decoded values to receive rewards without actually coming to the retail store.

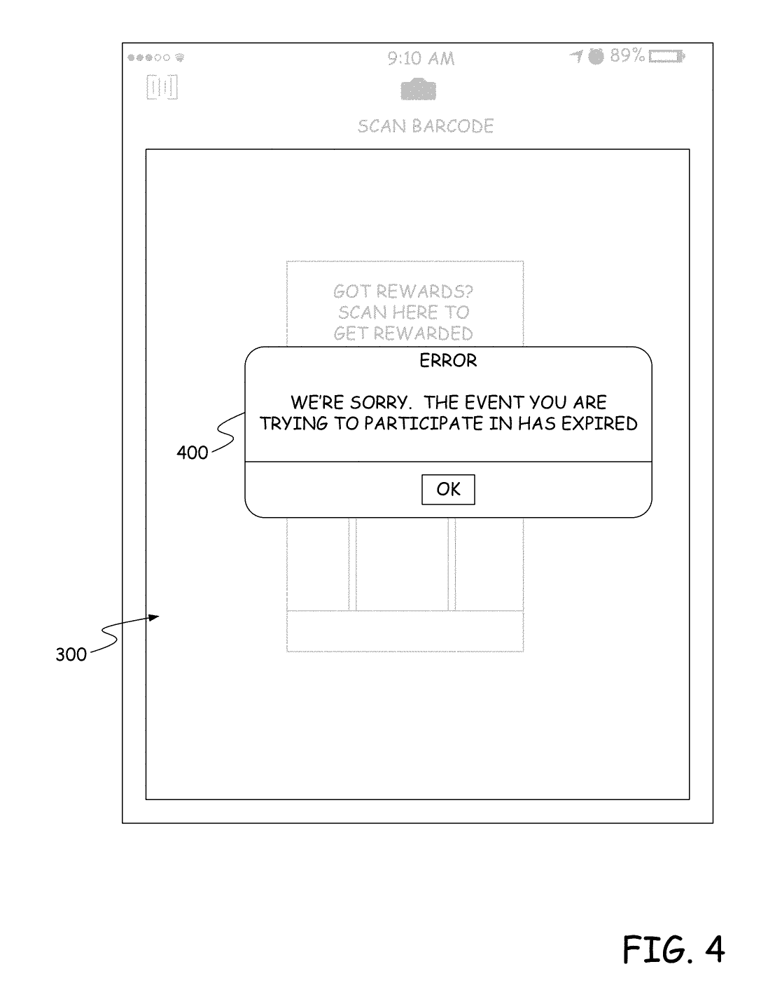

At step 104, rewards application 202 sends the decoded value, a rewards account number associated with the customer using the mobile device, a rewards account start date and the current date and time to an event processing application 212 on a rewards server 208 through a network 210. At step 106, event processing application 212 parses the decoded value to identify the event using the event start date, the event type and the event number. At step 108, event processing application 212 consults one or more event tables 214 to determine if the identified event has ended. An identified event can end as a result of the current date and time being after a set end date for the event or when all of rewards assigned to the event have been awarded to other customers. If the event has ended, event processing application 212 returns an error message to rewards application 202 at step 110. Rewards application 202 then displays the error at step 112 as shown in the user interface of FIG. 4. In particular, FIG. 4 displays an error 400 over barcode capturing user interface 300 of FIG. 3.

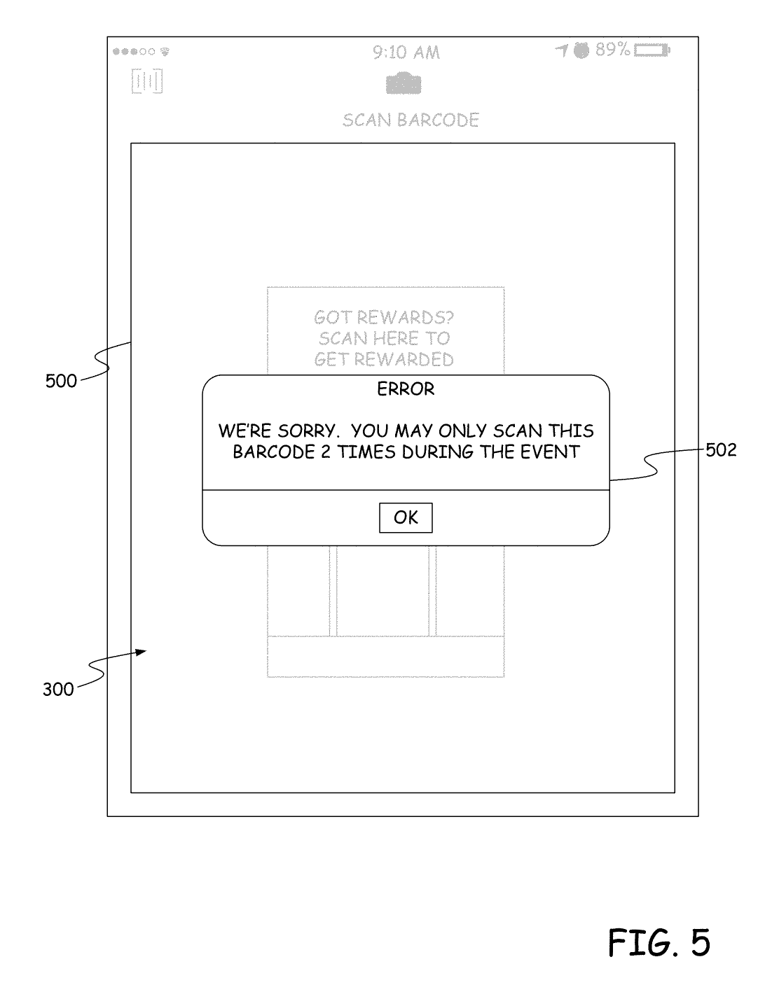

If event processing application 212 determines that the event is still active at step 108, event processing application 212 determines if the user of mobile device 200 has exceeded a maximum per user participation level for the event at step 114. For example, each event has a maximum number of times a single user can scan the event's barcode. The information about how often a customer has scanned a barcode for an event can be stored in event tables 214 or in a rewards account table 216 that contains information about what rewards have been assigned to each customer. If the customer has exceeded the per user participation level, event processing application 212 returns an error to rewards application 202 at step 116 and rewards application 202 displays an error message in a user interface at step 118. For example, in user interface 500 of FIG. 5, an error message 502 indicates that the user can only scan the barcode two times during the event. In the embodiment of FIG. 5, error message 502 is shown over barcode scanning user interface 300 of FIG. 3.

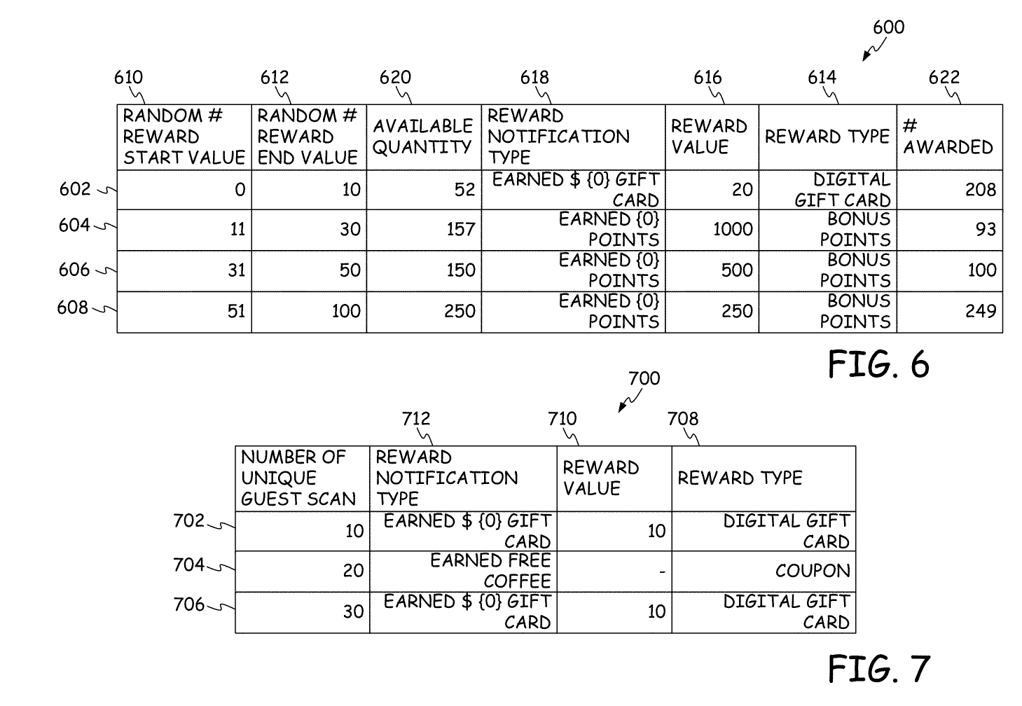

If the maximum per user participation level for the event has not been exceeded at step 114, the process continues at step 120 where event processing application 212 determines a reward to provide to the user of mobile device 200 based in part on the number of times the barcode has been scanned by other users during the event. In accordance with one embodiment, event processing application 212 determines the reward to provide using one of event tables 214 such as event table 600 of FIG. 6. Event table 600 includes a separate row for each reward that can be awarded during the event, such as row 602 for a $20.00 gift card, row 604 for 1000 bonus points, row 606 for 500 bonus points and row 608 for 250 bonus points. Each row is associated with a range of random numbers defined by a random number start value 610 and a random number end value 612. The reward type is found in a column 614 and the reward value is found in column 616. Text to be included in a reward notification is found in column 618 and the available quantity of the particular reward is found in column 620. The actual number of rewards awarded is found in column 622. Each time a reward is awarded, the available quantity 620 is decreased by one and the number awarded 622 is increased by one.

When using event table 600, event processing application 212 first assigns a random number between 1 and 100 to the current barcode scan and then searches table 600 for the row having a random number range defined by columns 610 and 612 that includes the random number assigned to the scan. Event processing application 212 then examines the available quantity of the reward for the identified row to determine if any of that reward is still available to be awarded. If the available quantity is equal to zero, event processing application 212 generates a new random number to select one of the other rows. In generating the new random number, the range of numbers assigned to the previously selected row can be removed from consideration. In some embodiments, event table 600 is evaluated at step 108 to ensure that at least one of the rows has an available quantity of rewards. If none of the rows have an available quantity, event processing application 212 determines that the event has expired and returns an error at step 110. Similarly, if any one of the rows has an available quantity of zero, the range of random values for that row can be removed during the generation of the random value for the barcode scan to thereby avoid selecting a row with no available rewards. Because the available quantity of a reward can drop to zero if enough previous customers have been given the reward, the reward provided to a present customer is dependent upon how many times the barcode has been previously scanned. Thus, the reward system is dynamic in that it is altering itself as customers scan the barcode.

The range of random numbers assigned to a reward controls the percentage of scans that will be assigned to that reward until one of the rewards reaches an available quantity of zero. For instance, the reward for row 608 has numbers 51-100 assigned to it meaning that 50% of the scans will be awarded the 250 bonus point reward of row 608 and row 602 has numbers 0-10 assigned to it meaning that 10% of the scans will be awarded the $20 gift card. When the available quantity of a reward reaches zero, the percentages of the scans given each reward changes based on the removal of that reward from consideration.

In an alternative embodiment, event processing application 212 uses an event table 700 of FIG. 7 to determine what reward is to be awarded. Event table 700 includes a separate row, such as rows 702, 704 and 706 for particular unique guest scans. For example, row 702 is for the 10^{th} unique guest scan, row 704 is for 20^{th} unique guest scan and row 706 is for the 30^{th} unique guest scan. Table 700 includes a reward type column 708, a reward value column 710 and reward notification type 712, which are similar to columns 614, 616 and 618 of FIG. 6.

Since the different rows of event table 700 have different rewards associated with them, the reward provided by event processing application 212 for any one scan is dependent upon the number of previous unique guest scans. Thus, when using event table 700, event processing application 212 provides a dynamic reward system that modifies itself to provide different rewards for different scans.

In some embodiments that use event table 700, scans that do not match one of the unique guest scans in table 700 are awarded a standard reward. In other embodiments, scans that do not match one of the unique guest scans in table 700 do not receive any reward.

At step 122 of FIG. 1, event processing application 212 updates a user entry in an event table, not shown, that keeps track of the number of times the user has scanned the barcode for this event. This entry is used in step 114 if the user scans the event barcode again.

At step 124, event processing application 212 updates a rewards account table 216 to reflect the awarding of the reward to the user's rewards account. At step 126, event processing application 212 sends information to rewards application 202 on mobile device 200 to indicate that the reward has been awarded to the user. This information can include the reward notification type 618, 712 and the reward values 616, 710 as well as a barcode for redeeming the reward, which is stored as reward 218 on mobile device 200. At step 128, rewards application 202 displays a user interface over the barcode scanning user interface indicating the reward that has been awarded to the user.

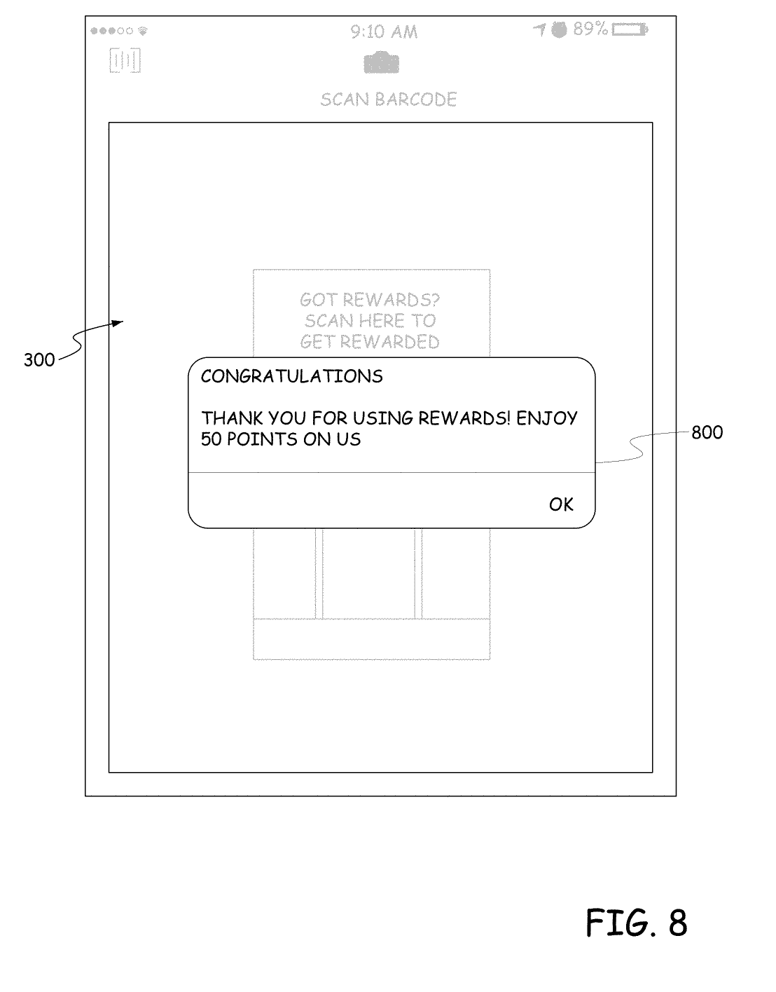

FIG. 8 provides an example of a user interface 800 displayed over barcode scanning user interface 300 that indicates that the user has been awarded 50 award points for scanning the barcode.

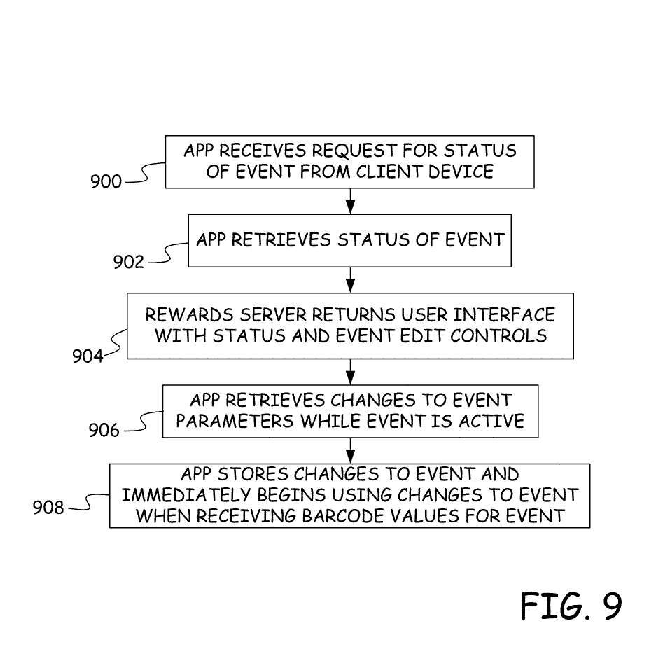

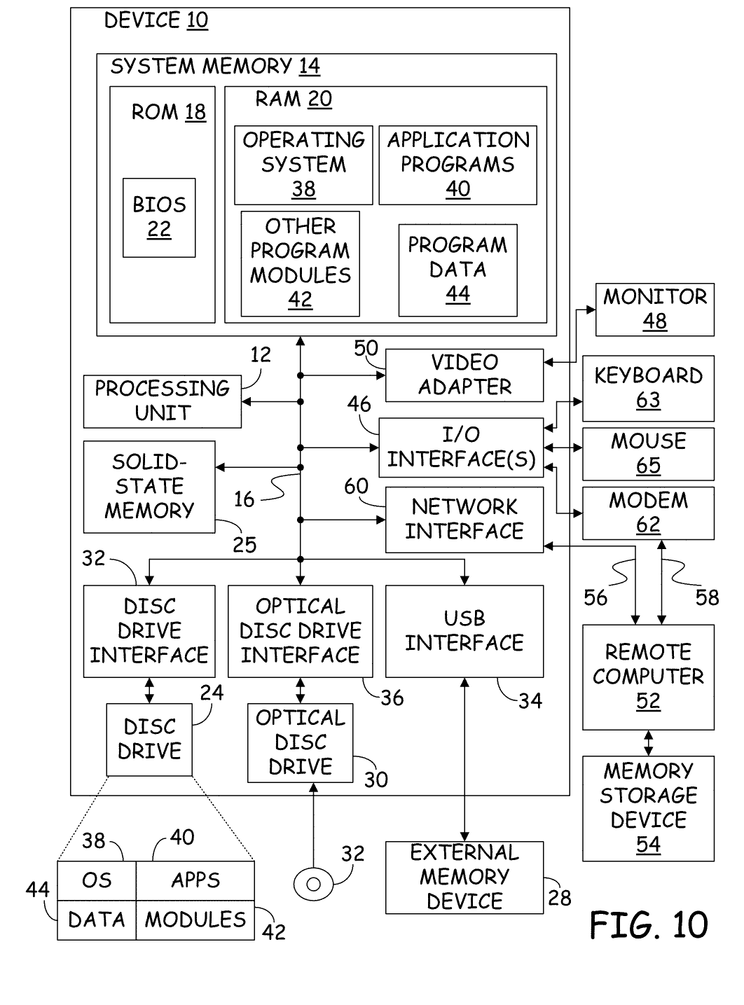

Because the event is dynamic and the rewards assigned to guests change as users scan the barcode, some embodiments provide means for an event designer to track the status of the event, such as how many times the barcode has been scanned and what rewards have been issued, and further allows the designer to modify the event in real-time while the event is taking place. FIG. 9 provides a flow diagram of one method for monitoring and altering an event in real-time.

At step 900 of FIG. 9, an event designer uses an event modification client device 240 having a display 242 to interact with an event modification application 244 on rewards server 208. In particular, event modification application 244 receives a request from event modification client device 240 for the status of a particular event. At step 902, event modification application 244 retrieves the status of the event using event table 214. At step 904, event modification application 244 returns a user interface to event modification client device 240 that shows the status of the event and includes edit controls that allow the event designer to modify parts of the events. These edit controls can include the ability to add new rewards, alter the reward type or reward value of an existing reward, alter the percentages of different types of rewards by altering the ranges of random values assigned to those rewards and/or modify the number of available rewards. Changing the ranges of random numbers assigned to a particular reward changes the chances of that particular reward being awarded at any one time. Thus, increasing the range for a particular reward increases the chances that the reward will be awarded for the next scan. This allows the event designer to give preference to particular rewards over other rewards at any time during the event.

At step 906, event modification application 244 receives the changes to the event parameters made using the edit controls on event modification client device 240. Event modification application 244 then stores the changes to the event such that event processing application 212 can immediately begin using the changes to the event when receiving barcode values for the event at step 908.

FIG. 10 provides an example of a computing device 10 that can be used as a server device or client device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of rewards app 202, event processing app 212, and event modification app 244, for example. Program data 44 may include data such as data in event tables 214, rewards account table 216 and reward 218, for example.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 10. The network connections depicted in FIG. 10 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46. Order 206 is received through either network interface 60 or modem 62.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 10 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
receiving a decoded value multiple times from multiple respective devices, each decoded value decoded from a respective image of a graphic; and
for each reception of the decoded value, identifying a reward that is to be awarded for providing the decoded value such that for any one reception of the decoded value, the reward is dependent in part on how many times the decoded value has been received.

2. The computer-implemented method of claim 1 wherein identifying a reward comprises randomly selecting the reward from a plurality of possible rewards while ensuring that a maximum number of the selected reward has not been previously awarded.

3. The computer-implemented method of claim 2 wherein randomly selecting the reward comprises assigning a respective range of values to each of the plurality of rewards, assigning a random number to the reception of the decoded value and determining which range of values the random value falls within.

4. The computer-implemented method of claim 1 further comprising before identifying the reward for a reception of the decoded value, determining whether an event associated with the decoded value is still active.

5. The computer-implemented method of claim 4 wherein determining whether the event is still active comprises determining whether a current date/time is after an end date/time for the event.

6. The computer-implemented method of claim 1 wherein selecting the reward comprises selecting the reward from a plurality of possible rewards, each reward in the plurality having a limited available quantity that can be awarded.

7. The computer-implemented method of claim 6 further comprising before identifying the reward for a reception of the decoded value, determining whether an event associated with the reception of the decoded value is still active by determining whether any of the rewards has an available quantity greater than zero.

8. A method comprising:
associating a graphic with an event taking place at a retail store;
receiving an identifier from a mobile device based on the mobile device capturing an image of the graphic;
selecting a reward from a plurality of rewards based on the received identifier and based in part on how many times the identifier has previously been received; and
sending a notification to the mobile device that the identified reward has been awarded.

9. The method of claim 8 wherein identifying a reward comprises randomly selecting a reward from the plurality of different rewards, wherein each of the different rewards has an available quantity of rewards left to be awarded during the event.

10. The method of claim 8 wherein identifying a reward comprises determining how many times the identifier has been received and retrieving a reward that has been previously designated for that number of times.

11. The method of claim 8 further comprising before identifying the reward, determining whether the event has expired.

12. The method of claim 11 wherein there are a plurality of different rewards and each reward has a number of remaining times the reward can be awarded and wherein determining whether the event has expired comprises determining whether any of the plurality of different rewards has any remaining times the reward can be awarded.

13. The method of claim 8 further comprising receiving a request for a status of an event and in response providing an indication of how many of each of a plurality of rewards have yet to be awarded.

14. The method of claim 13 further comprising receiving instructions to alter at least one parameter of a reward associated with the event.

15. A server comprising:
a memory holding at least one table describing an event at a retail store;
a processor performing steps comprising:
receiving an identifier for the event from a mobile device;
accessing the at least one table to determine which of a plurality of rewards to award, wherein the determination is affected by how many times the identifier has previously been received;
altering the at least one table to indicate that the identifier has been received an additional time; and
returning an indication to the mobile device that the determined reward has been awarded.

16. The server of claim 15 wherein determining which of the plurality of rewards to award comprises randomly selecting the reward.

17. The server of claim 16 wherein the processor performs further steps of receiving a change to the at least one table that alters the likelihood that a particular reward will be awarded.

18. The server of claim 17 wherein the server receives the change after the event has started and before the event has ended.

19. The server of claim 15 wherein determining which of the plurality of rewards to award comprises determining the number of times the identifier has been received and selecting a reward previously assigned to that number of times.

20. The server of claim 15 wherein the processor performs a further step of determining if the event has expired before determining which of the plurality of rewards to award.
